(19) United States
(12) Patent Application Publication
(10) Pub. No.: US 2026/0296348 A1
(43) Pub. Date: Oct. 1, 2026

(54) METHODS, SYSTEMS, AND DEVICES FOR A VEHICLE CRASH STRUCTURE WITH SELECTIVE PRESSURE CHAMBER

(71) Applicant: Toyota Motor Engineering & Manufacturing North America, Inc., Plano, TX (US)

(72) Inventors: Colby S. Williams, Saline, MI (US); Paxton S. Williams, Milan, MI (US)

(73) Assignees: Toyota Motor Engineering & Manufacturing North America, Inc., Plano, TX (US); Toyota Jidosha Kabushiki Kaisha, Toyota-shi (JP)

(21) Appl. No.: 19/092,465

(22) Filed: Mar. 27, 2025

(51) Int. Cl. B60R 19/32

(52) U.S. Cl. CPC B60R 19/32

(57) ABSTRACT

Methods, systems, and devices for a selective pressure chamber system for a vehicle. The system may include a structural component of the vehicle, an air compartment connected to the structural component, an inflator connected to the air compartment configured to inflate gas into the air compartment, and a sensor configured to detect an impact on a side or a portion of the vehicle. The system may include an electronic control unit (ECU). The ECU may detect, via the sensor, an impact on the side or the portion of the vehicle in close proximity to the sensor and upon detection of the impact, trigger inflation of the air compartment via the inflator to increase the amount of force against the structural component.

### BACKGROUND

### 1. Field

The present disclosure relates to methods, systems, and/or devices for a vehicle crash structure with a selective pressure chamber.

### 2. Description of the Related Art

Current vehicles may include a deployable airbag to protect passengers in the case of a crash. For example, in the event the vehicle gets into an accident, an airbag can inflate to protect the driver or passengers from injury. However, no mechanism currently exists to protect the vehicle structure or components in a similar fashion.

Accordingly, it is desirable to provide improved methods, systems, and devices for protecting the vehicle structure from damage due to an accident.

### SUMMARY

In general, one aspect of the subject matter described in this disclosure may be embodied in a selective pressure chamber system for a vehicle. The selective pressure chamber system may include a structural component of a vehicle, the structural component being located between an exterior environment of the vehicle and an interior cabin of the vehicle. The selective pressure chamber system may include an air compartment connected to the structural component configured to receive gas via an inlet into the air compartment and release gas via a vent hole coupled to the air compartment. The selective pressure chamber system may include an inflator connected to the air compartment configured to inflate gas into the air compartment via the inlet. The selective pressure chamber system may include a sensor spaced apart from the air compartment and configured to detect an impact on a side or a portion of the vehicle in close proximity to the sensor. The selective pressure chamber system may include an electronic control unit (ECU). The ECU may detect, via the sensor, an impact on the side or the portion of the vehicle in close proximity to the sensor and, upon detection of the impact, trigger inflation of the air compartment via the inflator to increase the amount of force against the structural component. The air compartment may be connected to the structural component in both a deployed state and an undeployed state. The air component is generally located outside a cabin of the vehicle and attached to and/or positioned on or adjacent to the structural component to protect.

In one aspect, the subject matter may be embodied in a method for inflating a vehicle pressure chamber in the event of an accident or a crash. The method may include detecting, via a sensor, an impact on the side or the portion of the vehicle in close proximity to the sensor. The sensor may be configured to detect an impact on a side or a portion of a vehicle in close proximity to the sensor. The method may further include upon detection of the impact, automatically and immediately triggering inflation of an air compartment via an inflator to increase the amount of force against and to protect a structural component of the vehicle. The air compartment may be connected to the structural component of the vehicle in both a deployed state and an undeployed state and configured to receive gas via an inlet into the air compartment and release gas via a vent hole coupled to the air compartment. The ECU can also control the release of the gas by adjusting (i.e., increasing or decreasing) the size of the vent hole to allow the gas to escape more quickly or more slowly.

In one aspect, the subject matter may be embodied in a vehicle including a system for inflating a vehicle pressure chamber in the event of an accident or a crash. The vehicle may include a structural component of a vehicle, the structural component being located between an exterior environment of the vehicle and an interior cabin of the vehicle. The structural component may also be located between a frame or a sheet metal of the vehicle and an interior cabin (e.g., a passenger compartment) of the vehicle. The vehicle may include an air compartment connected to the structural component configured to receive gas via an inlet into the air compartment and release gas via a vent hole coupled to the air compartment. The vehicle may include an inflator connected to the air compartment configured to inflate gas into the air compartment via the inlet. The vehicle may include a sensor spaced apart from the air compartment and configured to detect an impact on a side or portion of the vehicle in close proximity to the sensor. The vehicle may include an electronic control unit (ECU). The ECU may detect, via the sensor, an impact on the side or the portion of the vehicle in close proximity to the sensor and, upon detection of the impact, trigger inflation of the air compartment via the inflator to increase the amount of force against the structural component. The air compartment may be connected to the structural component in both a deployed state and an undeployed state.

### BRIEF DESCRIPTION OF THE DRAWINGS

Other systems, methods, features, and advantages of the present disclosure will be apparent to one skilled in the art upon examination of the following figures and detailed description. Component parts shown in the drawings are not necessarily to scale and may be exaggerated to better illustrate the important features of the present disclosure. In the drawings, like reference numerals designate like parts throughout the different views.

FIG. 1 is a block diagram of an example selective pressure chamber system for a vehicle according to an aspect of the disclosure.

FIG. 2 is a diagram of an example selective pressure chamber system incorporated into a vehicle according to an aspect of the disclosure.

FIGS. 3A, 3B, 3C, and 3D depict example placements of the selective pressure chamber system within the frame of a vehicle according to an aspect of the disclosure.

FIG. 4 illustrates an example diagram of a force stroke curve according to an aspect of the disclosure.

FIGS. 5A, 5B, and 5C illustrate example diagrams of possible force stroke curves according to aspects of the disclosure.

FIG. 6 is a flow diagram of an example process for controlling the selective pressure chamber system of FIG. 1 according to an aspect of the disclosure.

### DETAILED DESCRIPTION

Disclosed herein are methods, systems, devices, and/or vehicles for implementing a selective pressure chamber system. The selective pressure chamber system may include a structural component of a vehicle, an air compartment connected to the structural component, and a sensor configured to detect a crash or impact with the vehicle. The selective pressure chamber system may detect, via the sensor, that an impact has occurred on the structural component. After detecting the impact, the selective pressure chamber system can trigger the air compartment to inflate in order to increase the amount of force against the structural component. In this way, the air compartment can reduce the amount of crush that the structural component experiences from the crash.

The selective pressure chamber system can further provide an option to tune a vehicle's structural performance during a crash. The selective pressure chamber system can allow changes to be made to a vehicle's structural performance for crash safety without having to change the structure itself. The selective pressure chamber system can also provide several options to be selected from during the crash event. For example, a user can tune the performance based on how much and how quickly air is inflated into the air compartment as well as how much and how quickly air is released from the air compartment.

Particular aspects of the subject matter described in this disclosure may be implemented to realize one or more of the following advantages. The selective pressure chamber system can be utilized during a crash event by allowing for the vehicle structure to be tuned reactively during a crash and allow for more flexibility for future vehicle changes (e.g., variations to the body type, options, mass etc.). Crash safety has regulation items that need to be met. Furthermore, typically a vehicle's structure is set early in development of a new model or platform. It is therefore difficult to change the vehicle structure due to the effect on performance items (e.g., strength, durability, crash, vibrations, etc.) and effect on production (e.g., process changes, logistics, tooling change, etc.). As a result, after a vehicle is developed it is difficult to change any structural component of the vehicle that may affect crash safety due to the time it takes to test and build new tools for new parts. With current methods, any future development must rely on the original condition of the vehicle structure. New technologies, new regulations, etc. can be difficult to manage if the original vehicle structure cannot be tuned to accommodate the changes.

The selective pressure chamber system can allow for some tuning to accommodate for future changes by reducing the crush of the structure, as well as allowing for changes during the crash (e.g., by tuning the level of air pressure). The selective pressure chamber system can perform tuning by timing the crush area based on the retaining shape or allowing different shapes to be achieved by expanding an air compartment. The compartment's deployment timing, size, pressure etc. can all be adjusted. This will allow for more potential value chains, and potentially less development of future items.

The selective pressure chamber system described herein may include a structural component of a vehicle. The structural component may be located between an exterior environment of the vehicle and an interior cabin of the vehicle. The selective pressure chamber system may include an air compartment connected to the structural component configured to receive gas via an inlet into the air compartment and release gas via a vent hole coupled to the air compartment. The selective pressure chamber system may include an inflator connected to the air compartment configured to inflate gas into the air compartment via the inlet. The selective pressure chamber system may include a sensor spaced apart from the air compartment configured to detect an impact on a side or portion of the vehicle in close proximity to the sensor. The selective pressure chamber system may include an electronic control unit (ECU). The ECU may detect, via the sensor, an impact on the side or portion of the vehicle in close proximity to the sensor and, upon detection of the impact, trigger inflation of the air compartment via the inflator to increase the amount of force against the structural component. The air compartment may be connected to the structural component in both a deployed and undeployed state.

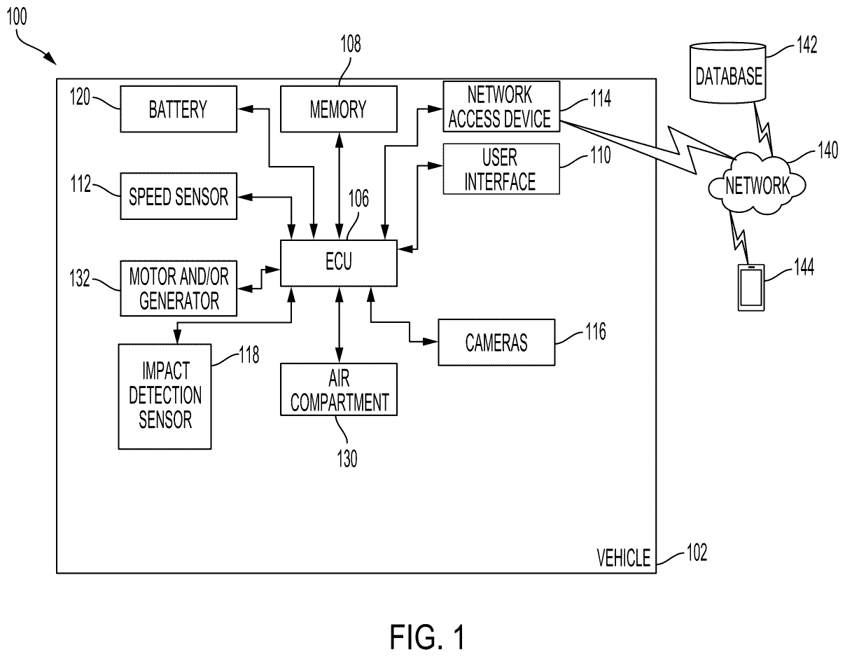

FIG. 1 is a block diagram for an example selective pressure chamber system 100. The selective pressure chamber system 100 or a portion thereof may be retrofitted, coupled to, include, or be included within a vehicle 102 or separate from the vehicle 102. The vehicle 102 may be a conveyance capable of transporting a person, an object, or a permanently or temporarily affixed apparatus. The vehicle 102 may be a self-propelled wheeled conveyance, such as a car, a sports utility vehicle, a truck, a bus, a van, a motorcycle, or other motor, battery, or fuel cell driven vehicle. For example, the vehicle 102 may be an electric vehicle, a hybrid vehicle, a plug-in hybrid vehicle, a hydrogen fuel cell vehicle, or any other type of vehicle that has a fuel cell, a motor, an engine, and/or a generator. Other examples of vehicles include bicycles, trains, planes, or boats, and any other form of conveyance that is capable of transportation. The vehicle 102 may be semi-autonomous or autonomous. That is, the vehicle 102 may be self-maneuvering and navigate without human input. An autonomous vehicle may have and use one or more sensors and/or a navigation unit to drive autonomously.

The selective pressure chamber system 100 and/or the vehicle 102 may include a motor and/or generator 132 and/or a battery 120. The motor and/or generator 132 may be located within an engine bay of the vehicle 102. For example, the motor and/or generator 132 may be an internal combustion engine (ICE). In this regard, the motor and/or generator 132 may combust an air and fuel mixture to provide power to the vehicle 102 and/or components of the vehicle 102 and/or the selective pressure chamber system 100. Accordingly, the motor and/or generator 132 can cause the vehicle 102 to accelerate, decelerate, or maintain a desired velocity. The motor and/or generator 132 may include combinations of an ICE and an electric motor, such as for hybrid electric vehicle (HEV) applications, for example. In examples, the motor and/or generator 132 may be an electric motor, such as for battery electric vehicle (BEV) applications, for example. In this regard, the motor and/or generator 132 may be an electric motor and an electric generator that converts electrical energy into mechanical power, such as torque, and converts mechanical power into electrical energy. The motor and/or generator 132 may be electrically connected to the battery 120. The motor and/or generator 132 may convert energy from the battery 120 into mechanical power, and may provide energy back to the battery 120, for example, via regenerative braking. The battery 120 may be electrically connected to the motor and/or generator 132 and may provide electrical energy to and/or receive electrical energy from the motor and/or generator 132. The battery 120 may provide electrical energy to the selective pressure chamber system 100.

The selective pressure chamber system 100 and/or the vehicle 102 may further include one or more processors, such as an electronic control unit (ECU) 106. The ECU 106 may be implemented as a single ECU or in multiple ECUs. The ECU 106 may be electrically connected to some or all of the components of the vehicle 102 and/or the selective pressure chamber system 100 (e.g., via a controller area network (CAN) bus and/or other protocols). For example, the ECU 106 may be electrically connected to an air compartment 130, the motor and/or generator 132, the battery 120, a memory 108, a user interface 110, a network access device 114, a speed sensor 112, one or more cameras 116, and/or an impact detection sensor 118. The ECU 106 may include one or more processors (or controllers) specifically designed for controlling operations of the vehicle 102, such as accelerating, braking, autonomous driving, parking (or parking assistance), etc. Moreover, the ECU 106 may control a panoramic view monitor (PVM) of the vehicle 102 (e.g., including the user interface 110 and/or the one or more cameras 116). In examples, the ECU 106 may be and/or include an ADAS sensor fusion ECU, a PVM ECU, an engine control module (ECM), a transmission control module (TCM), a telematics control unit (TCU), an inertial measurement unit (IMU), an in-vehicle infotainment (IVI) ECU, a graphics processing unit (GPU), and/or an artificial intelligence (AI) chip or processor.

The selective pressure chamber system 100 may further include the memory 108. The memory 108 may be electrically connected to the ECU 106. In examples, the memory 108 may be communicatively coupled (e.g., via a network 140 and/or the network access device 114) to the ECU 106 such that the memory 108 is remote from the ECU 106 and/or the vehicle 102. In other examples, the memory 108 may be electrically connected to the ECU 106 and a remote memory (e.g., a remote database 142) may be communicatively coupled to the ECU 106, with the remote memory having similar, additional, and/or different functions as the memory 108 (e.g., greater storage capacity, enabling over-the-air updates, etc.). The memory 108 may store instructions to execute on the ECU 106 and may include one or more of a random access memory (RAM) or other volatile or non-volatile memory. The memory 108 may be a non-transitory memory or a data storage device, such as a hard disk drive, a solid-state disk drive, a hybrid disk drive, or other appropriate data storage, and may further store machine-readable instructions, which may be loaded and executed by the ECU 106. The memory 108 may store vehicle parameters (e.g., a weight of the vehicle 102, dimensions of the vehicle 102, transmission gear information of the vehicle 102, etc.).

The selective pressure chamber system 100 may further include the user interface 110. The user interface 110 may be located within a cabin of the vehicle 102 (e.g., coupled to a dashboard of the vehicle 102). The user interface 110 may provide an interface to a user of the vehicle 102 (e.g., a driver and/or a passenger of the vehicle 102) to interact with and/or receive output from the ECU 106. The user interface 110 may have a user interface element, such as a screen and/or a touchscreen with a button, a switch, a microphone, a speaker, a gesture monitoring sensor, a knob, a graphical user interface (GUI), and/or other input/output devices electrically connected to the ECU 106 to provide input and/or output of information (or data) to and/or from the ECU 106.

The selective pressure chamber system 100 may further include the network access device 114. The network access device 114 may be electrically connected to the ECU 106 and may include a communication port or channel, such as one or more of a Wi-Fi unit, a Bluetooth® unit, a Radio Frequency Identification (RFID) tag or reader, a Dedicated Short Range Communications (DSRC) unit, a satellite network unit, and/or a cellular network unit for accessing the network 140 (e.g., CDMA, GSM, 3G, 4G, 5G, etc.). The network access device 114 may transmit data to and receive data from devices and systems not directly connected to the vehicle 102. For example, the ECU 106 may communicate with the remote database 142 and/or a user device 144 (e.g., a mobile device, a phone, a tablet, a laptop, etc.) through the network access device 114.

The selective pressure chamber system 100 may further include the speed sensor 112. In examples, the selective pressure chamber system 100 may include a plurality of speed sensors. The speed sensor 112 may be electrically connected to the ECU 106. The speed sensor 112 may be configured to measure, detect, and/or determine the current speed of the vehicle 102. For example, the speed sensor 112 may be and/or include an electronic vehicle speed sensor (e.g., that measures rotation of the motor and/or generator 132 and/or a transmission shaft of the vehicle 102) and/or one or more wheel speed sensors (e.g., that measure rotation of one or more wheels of the vehicle 102). In examples, the speed sensor 112 may provide speed data indicating the current speed of the vehicle 102 to the ECU 106. The ECU 106 and/or the speed sensor 112 may determine the current speed of the vehicle 102 (e.g., in miles per hour (MPH) and/or kilometers per hour (KPH)) based on the speed data.

The selective pressure chamber system 100 may further include the one or more cameras 116. The one or more cameras 116 may be coupled to an exterior of the vehicle 102 and/or an interior of the vehicle 102 such that the one or more cameras 116 look out toward a surrounding area of the vehicle 102. The one or more cameras 116 may be and/or include one or more of an analog camera, a digital camera, a thermal camera, and/or a night vision camera (e.g., utilizing active illumination and/or image intensification). The one or more cameras 116 may provide, capture, and/or record images and/or real-time video of the surrounding area of the vehicle 102. In examples, the one or more cameras 116 (e.g., via the ECU 106) may also have pattern recognition capabilities to view the surrounding area and identify, for example, vehicles, components of vehicles (e.g., a license plate, a side view mirror, vehicle lamps, etc.), road signs (e.g., speed limit signs), and/or writing (e.g., letters, numbers, symbols, etc.) on the vehicles and/or the road signs.

The selective pressure chamber system 100 may further include the impact detection sensor 118. The impact detection sensor 118 may be a type of pressure sensor or accelerometer that is configured to detect an impact on a side or portion of the vehicle 102 in close proximity to the sensor 118. The impact detection sensor 118 may sense an impact with the vehicle 102 and send a signal to the ECU 106 indicating that an impact was detected. The impact detection sensor 118 may be spaced apart from the air compartment 130 and coupled to the exterior of the vehicle. For example, the impact detection sensor 118 may be located on a front, side, and/or back of the vehicle. A location of the impact detection sensor 118 on the vehicle 102 may be known to the ECU 106 (e.g., the location of each of the impact detection sensor 118 may be stored in or on the memory 108). Therefore, if an impact is detected, the ECU 106 may identify the location of the impact based on the location of the impact detection sensor 118.

The selective pressure chamber system 100 may further include the air compartment 130. The air compartment 130 may be connected to a structural component of the vehicle 102, the structural component being located between an exterior environment of the vehicle 102 and an interior cabin of the vehicle 102. The air compartment 130 may be positioned in front of, behind, or within the structural component. The air compartment 130 may be configured to receive gas via an inlet into the compartment 130 and can release gas via a vent hole coupled to the compartment 130. The air compartment 130 may be a bag that can maintain an airtight seal while providing pressure to a structural member of the vehicle 102. The air compartment 130 may be made out of material that is thick enough to protect it from damage during a crash. In some aspects, the air compartment 130 may have a protective coating to protect it from crash damage.

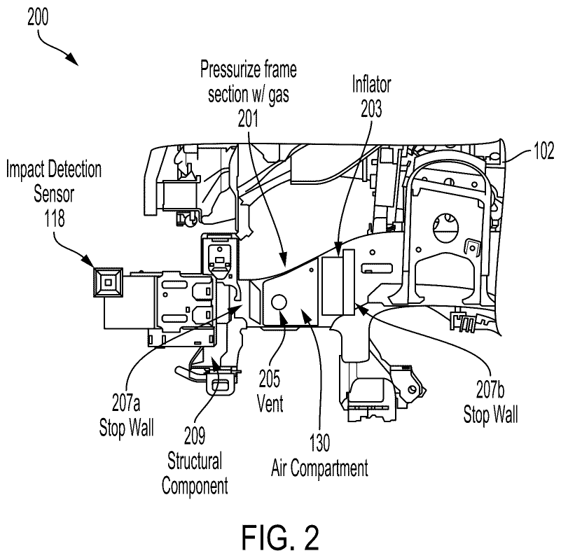

FIG. 2 is a diagram 200 of an example selective pressure chamber system 100 incorporated into the vehicle 102 according to an aspect of the disclosure. The selective pressure chamber system 100 may include a pressurized frame section 201 (with gas), an inflator 203, the air compartment 130, a vent 205, stop walls 207a and 207b, the impact detection sensor 118, and a structural component 209. The impact detection sensor 118 may detect when a crash and/or impact occurs against the structural component 209. The impact detection sensor 118 may send a signal to the ECU (e.g., ECU 106 of FIG. 1) that an impact has occurred. After receiving a signal that an impact has occurred, the ECU may trigger the inflator 203 to pressurize the frame 201 with gas at the given time. The selective pressure chamber system 100 can apply a force upon the structural component 209. Optionally, the vent 205 can release pressure as the frame section 201 is crushed, damaged or impacted.

The selective pressure chamber system 100 can use pressure in the frame of the vehicle 102 to tune the force stroke curve of key structural members of the vehicle 102 during a crash. The force stroke curve may refer to the amount of force applied to a vehicle during a crash compared to the deformation distance (e.g., “stroke”) of the vehicle structure. The selective pressure chamber system 100 can pressurized the frame section 201 to apply force to the structural component 209. In examples, the frame section 201 may include the air compartment 130 that can tune the force stroke curve by adjusting the pressure amount and the pressure timing.

The inflator 203 can pressurize the closed frame section 201 upon command (e.g., via a trigger from the ECU 106 upon detection of impact by the impact detection sensor 118) by inserting air into the air compartment 130. In some aspects, the inflator may pressurize the structural component 209 itself (assuming the structural component 209 is airtight) or the air compartment 130 within the structural component 209. The pressurized portion (e.g., either the air compartment 130 or the pressurized structural component 209) may be airtight, except when as designed with a vent hole 205, to maintain a force upon the structural component 209. The selective pressure chamber system 100 can cause the inflator 203 to put an initial amount of gas into the air compartment 130 of the closed frame section 201. Then, the inflator 203 can put a secondary amount of gas into the air compartment 130 of the closed frame section 201 to change the amount of pressure inside. The pressure inside the air compartment 130 can be controlled by the vent 205. For example, the selective pressure chamber system 100 can tune the vent 205 to a specific size to adjust the rate at which air is released from the air compartment 130. The amount of pressure inside the closed frame section 201 can increase the amount of force against the structural component 209 as its crushed. Therefore, if more pressure is desired, the selective pressure chamber system 100 can create another stage of inflation to increase the amount of gas. If less pressure is desired, the selective pressure chamber system 100 can allow gas to escape through the vent 205 to reduce the amount of gas and corresponding pressure.

The selective pressure chamber system 100 can tune the pressure by adjusting (i) the amount of gas released, (ii) the timing of the gas release, or (iii) the ability for gas to escape (e.g., through the vent 205). This will allow for multiple force stroke scenarios to be easily chosen and to allow for optimal energy absorption to a given crash mode or vehicle condition. For example, the amount and timing of gas released may be controlled by when and/or how long the vent 205 is open. The vent 205 hole size may also be changed to adjust the rate at which the gas is escaping the air compartment 130 (e.g., a larger vent 205 will allow gas to escape at a faster rate than a smaller vent 205).

In addition, the selective pressure chamber system 100 may include rigid “stops” in the frame so that the compartment 130 has a hard wall to push against along the length of the frame or member, shown as stop walls 207a and 207b in FIG. 2. The stop walls 207a and 207b can allow enough pressure to hold the side walls and ultimately, the frame section 201 with the use of the air compartment 130. The stop walls 207a and 207b can maintain the pressurized frame section 201 in place when the air compartment 130 is inflated. The air compartment 130 may produce equal pressure on all sides. The stop walls 207a and 207b can hold the air compartment 130 to allow enough pressure while also not expanding the air compartment 130 beyond its capability. The stop walls 207a and 207b can be integrated into the frame of the vehicle 102. In one aspect, the stop walls 207a and 207b may be positioned on either side of the pressurized frame section 201 and inflator 203.

In some embodiments, an inflator mounting as part of the inflator 203 could act as the stop wall in one direction. The inflator mounting can be welded in or be plastic injection molded. In one aspect, the inflator mounting can be glass filled for extra strength and/or with clips to insert the inflator mounting into predetermined holes in the frame. The inflator mounting may also be attached and be part of the air compartment 130 sub assembly itself.

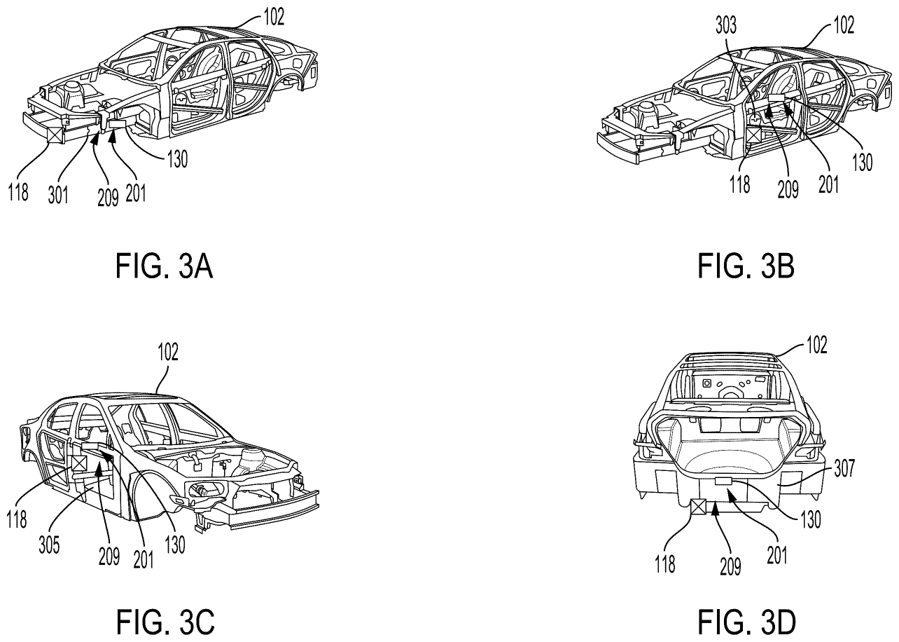

FIGS. 3A, 3B, 3C, and 3D depict example placements of the selective pressure chamber system 100 within the frame of the vehicle 102. As shown in FIG. 3A, the pressurized frame section 201 may be positioned in the front section of the vehicle 102 (such as in a front bumper 301). The air compartment 130 may correspondingly be placed in the front frame section in order to put pressure against the structural component 209, located in the front of the vehicle 102. Accordingly, the sensor 118 may be located on the front of the vehicle 102.

As shown in FIG. 3B, the pressurized frame section 201 may be positioned in the left side portion of the vehicle 102 (such as in a left side door 303). The air compartment 130 may correspondingly be placed in the left side frame section in order to put pressure against the structural component 209, located in the left side of the vehicle 102. Accordingly, the sensor 118 may be located on the left side of the vehicle 102.

As shown in FIG. 3C, the pressurized frame section 201 may be positioned in the right side portion of the vehicle 102 (such as in a right side door 305). The air compartment 130 may correspondingly be placed in the right side frame section in order to put pressure against the structural component 209, located in the right side of the vehicle 102. Accordingly, the sensor 118 may be located on the right side of the vehicle 102.

As shown in FIG. 3D, the pressurized frame section 201 may be positioned in the back section of the vehicle 102 (such as in a back bumper 307). The air compartment 130 may correspondingly be placed in the back frame section in order to put pressure against the structural component 209, located in the back of the vehicle 102. Accordingly, the sensor 118 may be located on the back of the vehicle 102, such as on the back bumper 307.

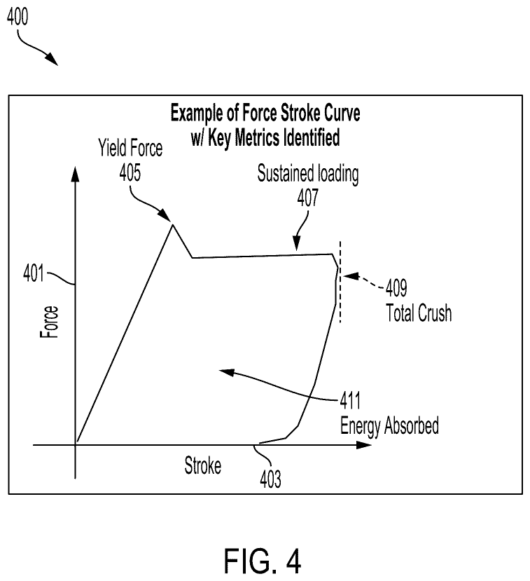

FIG. 4 illustrates an example diagram 400 of a force stroke curve according to an aspect of the disclosure. The diagram depicts an example force stroke curve of vehicle crush, with the amount of force 401 being on the y axis and the amount of stroke 403 being on the x axis. The curve may represent the condition of the vehicle structure crushing by itself (e.g., without incorporating the selective pressure chamber system 100), where stroke 403 can be the total amount of crush. The initial yield force 405 may represent the maximum force exerted on the vehicle structure during a crash. The initial yield force 405 may initially bring the force stroke curve down, then sustained loading 407 (e.g., sustained level of force) can maintain the curve at a certain level. The total crush 409 can be reached when the force 401 (e.g., from the impact) stops and therefore the level of stroke 403 also stops. The energy absorbed 411 by the structure may be the area under the curve.

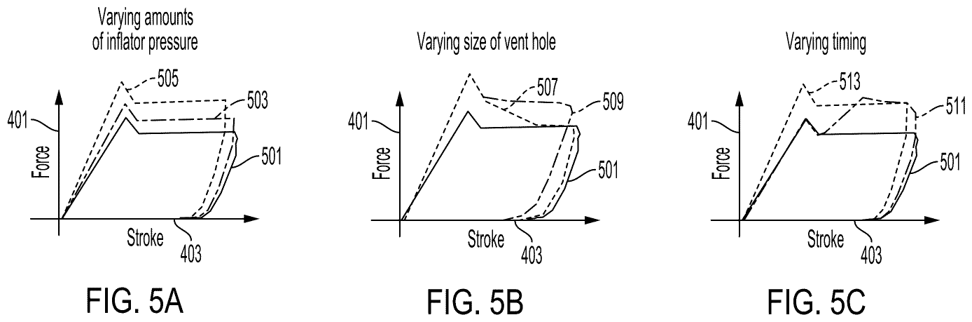

The force stroke curve can be tuned for optimal performance. Typically, to change the force stroke curve characteristics, structural material or a shape change needs to be implemented. However, in order to achieve an expected force stroke curve, the selective pressure chamber system 100 can be used to balance several performance items without new structural material or shape changes, as described in further detail below with respect to FIGS. 5A, 5B, and 5C.

FIGS. 5A, 5B, and 5C illustrate example diagrams of possible force stroke curves according to aspects of the disclosure. The solid curve 501 in each diagram can represent the condition of the frame crushing by itself (e.g., without using the selective pressure chamber system of FIG. 1). FIG. 5A depicts varying amounts of inflator pressure in the pressurized frame section 201. As depicted, the more pressure inflated (e.g. via more force 401) into the air compartment 130 within the frame section 201, the less amount of stroke 403 results. Therefore, an increase in the amount of pressure would reduce the amount of stroke 403. A further increase in pressure would result in a higher increase in force 401 over what the frame was already providing and shorten the total amount of stroke 403. For example, force stroke curve 503 depicts an increase in pressure which results in a decrease in stroke 403. As another example, force stroke curve 505 depicts an even larger increase in pressure which results in an even larger decrease in stroke 403.

FIG. 5A depicts a force stroke curve 503 in a case where pressure increase results in force increase and a total stroke decrease. In a case where the goal is to have the total stroke decrease (for example, to reduce intrusion into the cabin area, perhaps due to increased mass or for any other change to the vehicle that may affect crash performance but changing the frame is not desirable), the selective pressure chamber system 100 would increase the pressure and therefore force. The same can be said in the opposite manner where the goal is to increase stroke to reduce the acceleration on the occupant. This would mean lowering the pressure to reduce the force and lengthen the amount of crush stroke.

FIG. 5B depicts the force stroke curve with varying sizes of the vent 205 hole. After loading the crushed member, a change in size of the vent 205 hole can correspondingly change the slope of the drop in pressure. Increasing the size of the vent 205 hole may cause the drop in pressure to occur more quickly. For example, force stroke curve 507 depicts an increased amount of pressure initially, followed by a sharp drop in pressure as a result of a larger vent 205 hole. By contrast, force stroke curve 509 depicts an increased amount of pressure initially, followed by a steady drop in pressure as a result of a smaller sized vent 205 hole (as compared to curve 507). In examples, the selective pressure chamber system 100 can tune between different vent hole sizes to help with different test modes for crash testing. Tuning the vent hole size can be particularly helpful if a user wishes to add accessories to the vehicle, such as side steps, that may add mass to the vehicle. With the additional mass, to maintain the original stroke, additional energy may need to be absorbed. As an example, a user may wish the pressure to be high at the beginning, but low at the end when there may be speed changes between different crash tests.

FIG. 5B references a case where the increase in pressure is reduced over time due to vent hole leaking pressure. This may result in a varying amount of force over time. As the pressure chamber is being crushed, the total volume inside will reduce. As the total volume inside is reduced, the pressure will increase. Therefore, for example, selecting a specific vent hole size can result in the pressure maintaining at a similar amount as the pressure chamber is crushed. If the pressure chamber crush force varies over crush stroke (for example, low force initially and high force later) then changing the vent hole size can accommodate for this variation to make the overall force of the system more consistent if desired.

FIG. 5C depicts the force stroke curve with varying timing of air compartment inflation. In one aspect, the selective pressure chamber system 100 can delay inflation of the air compartment until after the start of the crash, as shown in force stroke curve 511. Varying the timing of air compartment inflation may be useful, for example, where a crash test might utilize more energy to absorb but different criteria for occupancy protection, such as for a 35 mph frontal flat ridged barrier test, where an occupant is in belted condition. As another example, for a 25 mph frontal flat ridged barrier test, the occupant may be unbelted and therefore, the overall force is lower because the occupant doesn't have restraints. By contrast, force stroke curve 513 shows sustained air compartment inflation.

FIG. 5C references a case where pressure is released into the chamber in multiple stages (two in this example). This results in an increase in pressure and therefore force at a selected time. For example, this can be used if the force should be lower for a lower speed test (e.g. 25 mph frontal flat ridged barrier) due to crash test setup conditions and dummy injury criteria, but force should be increased for a higher speed test (e.g., 35 mph frontal flat ridged barrier).

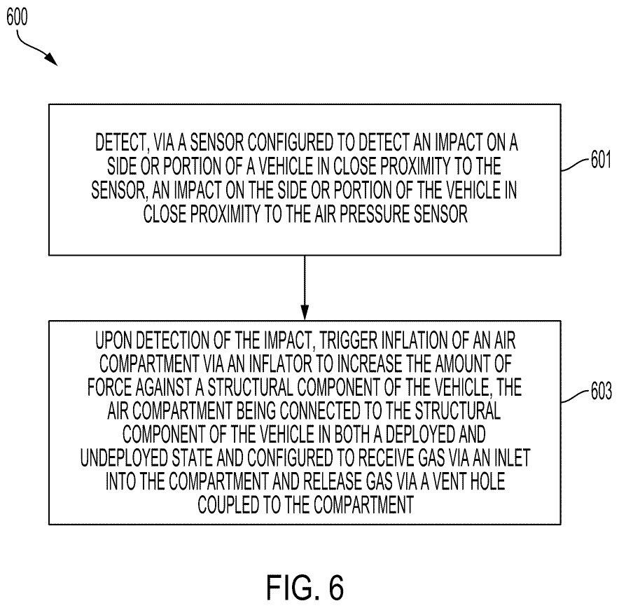

FIG. 6 is a flow diagram of an example process 600 for controlling the selective pressure chamber system of FIG. 1 according to an aspect of the disclosure. One or more computers or one or more data processing apparatuses, for example, the ECU 106 of the selective pressure chamber system 100 of FIG. 1, appropriately programmed, may implement the process 600. For ease of description, the process 600 is described below with reference to FIGS. 1-5. The process 600 of the present disclosure, however, is not limited to use of the exemplary selective pressure chamber systems of FIGS. 1-5.

At block 601, the selective pressure chamber system 100 may detect, via a sensor configured to detect an impact on a side or a portion of a vehicle in close proximity to the sensor, an impact on the side or the portion of the vehicle in close proximity to the sensor.

At block 603, the selective pressure chamber system 100 may, upon detection of the impact, trigger inflation of an air compartment via an inflator to increase the amount of force against a structural component of the vehicle, the air compartment being connected to the structural component of the vehicle in both a deployed state and an undeployed state and configured to receive gas via an inlet into the air compartment and release gas via a vent hole coupled to the air compartment.

The components of the selective pressure chamber system 100 may be configured in the following manner. The air compartment may be connected to the structural component. However, the air compartment may not be seen by a passenger of the vehicle 102 when in either an undeployed state or a deployed state and the air compartment may not come into direct contact with a passenger when in the deployed state. The sensor may be positioned on the exterior of the vehicle adjacent to the structural component but be spaced apart from an air compartment. The structural component may be located between an exterior environment of the vehicle and an interior cabin of the vehicle. For example, the structural component may be located on a front side, a left side, a right side, and/or a back side of the vehicle 102. The inflator may be connected to the air compartment and configured to inflate gas into the compartment via the inlet. In some aspects, the inflator may be surrounded by a protective casing in order to protect it from damage in the case of impact.

The selective pressure chamber system 100 may further include a first stop wall coupled to the air compartment and positioned on a first side of the air compartment and a second stop wall coupled to the air compartment and positioned on a second side of the air compartment. The first stop wall and the second stop wall may be configured to hold the air compartment in place.

The selective pressure chamber system 100 may further trigger, via the ECU 106, deflation of the air compartment by causing gas to release from the air compartment by opening the vent hole. In examples, the selective pressure chamber system 100 may activate or trigger, via the ECU 106, a release of air inside the air compartment at an increasing rate by increasing the size of the vent hole to reduce pressure inside the air compartment. In this case, the size of the vent hole is adjustable.

In some aspects, the pressure chamber system 100 may further detect from the sensor, via the ECU 106, additional impact on the side or portion of the vehicle in close proximity to the sensor. In response, the pressure chamber system 100 can activate or trigger further inflation of the air compartment to further increase the amount of force against the structural component.

Exemplary aspects of the invention have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such aspects that reasonably fall within the scope of the advancement to the art hereby contributed, and that that scope shall not be restricted, except in light of the appended claims and their equivalents.

What is claimed is:

1. A system for inflating a vehicle pressure chamber in the event of a crash, comprising:
a structural component of a vehicle, the structural component being located between an exterior environment of the vehicle and an interior cabin of the vehicle;
an air compartment connected to the structural component configured to receive gas via an inlet into the air compartment and release gas via a vent hole coupled to the air compartment;
an inflator connected to the air compartment configured to inflate gas into the air compartment via the inlet;
a sensor spaced apart from the air compartment and configured to detect an impact on a side or a portion of the vehicle in close proximity to the sensor; and
an electronic control unit (ECU) coupled to the sensor and the inflator, and configured to:
detect, via the sensor, an impact on the side or portion of the vehicle in close proximity to the sensor; and
upon detection of the impact, trigger inflation of the air compartment via the inflator to increase the amount of force against the structural component, the air compartment being connected to the structural component in both a deployed and undeployed state.

2. The system of claim 1, further comprising:
a first stop wall coupled to the air compartment and positioned on a first side of the air compartment; and
a second stop wall coupled to the air compartment and positioned on a second side of the air compartment, the first stop wall and the second stop wall being configured to hold the air compartment in place.

3. The system of claim 1, wherein the ECU is further configured to:
trigger deflation of the air compartment by causing gas to release from the air compartment by opening the vent hole.

4. The system of claim 1, wherein the ECU is further configured to:
trigger a release of air inside the air compartment at an increasing rate by increasing the size of the vent hole to reduce pressure inside the air compartment, wherein the size of the vent hole is adjustable.

5. The system of claim 1, wherein the ECU is further configured to:
detect, via the sensor, additional impact on the side or portion of the vehicle in close proximity to the sensor; and
trigger further inflation of the air compartment to further increase the amount of force against the structural component.

6. The system of claim 1, wherein the inflator is surrounded by a protective casing to protect the inflator in the case of impact.

7. The system of claim 1, wherein the air compartment is positioned within the structural component to pressurize the structural component itself.

8. The system of claim 7, wherein the structural component and the air compartment are airtight to maintain a force upon the structural component.

9. The system of claim 1, wherein the ECU is further configured to:
determine a change to the vehicle that affects crash performance; and
trigger further inflation of the air compartment to further increase the amount of force against the structural component and offset the change to the vehicle.

10. The system of claim 9, wherein the change comprises increased mass to the vehicle or changed body type of the vehicle.

11. The system of claim 1, wherein the air compartment is not seen by a passenger when in an undeployed state or a deployed state.

12. The system of claim 1, wherein the air compartment does not come into direct contact with a passenger in a deployed state.

13. A method for inflating a vehicle pressure chamber in the event of a crash, the method comprising:
detecting, via a sensor configured to detect an impact on a side or portion of a vehicle in close proximity to the sensor, an impact on the side or portion of the vehicle in close proximity to the sensor; and
upon detection of the impact, triggering inflation of an air compartment via an inflator to increase the amount of force against a structural component of the vehicle, the air compartment being connected to the structural component of the vehicle in both a deployed and undeployed state and configured to receive gas via an inlet into the air compartment and release gas via a vent hole coupled to the air compartment.

14. The method of claim 13, wherein a first stop wall coupled to the air compartment and positioned on a first side of the air compartment and a second stop wall coupled to the air compartment and positioned on a second side of the air compartment are configured to hold the air compartment in place.

15. The method of claim 13, further comprising:
triggering deflation of the air compartment by causing gas to release from the air compartment by opening the vent hole.

16. The method of claim 13, further comprising:
triggering a release of air inside the air compartment at an increasing rate by increasing the size of the vent hole to reduce pressure inside the air compartment, wherein the size of the vent hole is adjustable.

17. The method of claim 13, further comprising:
detecting, via the sensor, additional impact on the side or portion of the vehicle in close proximity to the sensor; and
triggering further inflation of the air compartment to further increase the amount of force against the structural component.

18. The method of claim 13, wherein the inflator is surrounded by a protective casing to protect the inflator in the case of impact.

19. A vehicle including a system for inflating a vehicle pressure chamber in the event of a crash, the vehicle comprising:
a structural component of the vehicle, the structural component being located between an exterior environment of the vehicle and an interior cabin of the vehicle;
an air compartment connected to the structural component configured to receive gas via an inlet into the air compartment and release gas via a vent hole coupled to the air compartment;
an inflator connected to the air compartment configured to inflate gas into the air compartment via the inlet;
a sensor spaced apart from the air compartment configured to detect an impact on a side or portion of the vehicle in close proximity to the sensor; and
an electronic control unit (ECU) coupled to the sensor and the inflator, and configured to:
detect, via the sensor, an impact on the side or portion of the vehicle in close proximity to the sensor; and
upon detection of the impact, trigger inflation of the air compartment via the inflator to increase the amount of force against the structural component, the air compartment being connected to the structural component in both a deployed and undeployed state.

20. The vehicle of claim 19, wherein the ECU is further configured to:
trigger deflation of the air compartment by causing gas to release from the air compartment by opening the vent hole.
